(19) United States
(12) Patent Application Publication
(10) Pub. No.: US 2004/0150373 A1
(43) Pub. Date: Aug. 5, 2004

(54) Vehicle jump starter with polarity compensation

(76) Inventor: Sing Chan, Pasadena, CA (US)

Correspondence Address: SING CHAN, 1122 E. GREEN STREET, PASADENA, CA, 91106, US

(21) Appl. No.: 10/353,994

(22) Filed: Jan. 30, 2003

(51) Int. Cl. H02J 7/14

(52) U.S. Cl. 320/165

(57) ABSTRACT

The subject invention is about a portable battery jump starting device for stranded vehicle due to weaken starting battery. It is equipped with a pair of power cable connected to crocodile clips. The internal circuit of the subject invention is capable of detecting polarity at the point of connection to the external battery and is capable of compensating a wrong polarity connection. The subject invention offers automatic power on/off and a will guarantee a correction connection at any circumstance. Therefore it eliminates the risk of battery explosion due to human error.

### BACKGROUND OF THE INVENTION

The subject invention is about a new control circuit that will achieve correct polarity connection between a portable battery pack and the weakened battery inside a stalled vehicle in all circumstances. Once detecting a connection, the control circuit of the subject invention will automatically determine the manner of an internal engagement of the internal battery and the output crocodile clip so that the polarity between the internal and external batteries will always match. Like other jump starter, the portable battery pack of this subject invention also carries two output crocodile clips. Yet, neither clip is a designated positive clip nor a negative clip. The internal circuit will determine which clip should become positively charged in light of the way they are connected to the external battery.

There is prior act capable of accomplishing the same purpose—either clip could be connected to the positive source or the negative source of the outside battery. Whiting, et al. disclosed an art in U.S. Pat. No. 6,130,519 about using an On/Off polarity switch. The design of the switch is made of a single plunger of two pairs of contact (4 points), double pole, double throw, inside a 3 layers coil relay system. The design of this relay calls for a multi fin bobbin to separate the multi coils.

Chan disclosed another art in U.S. Pat. No. 6,212,054 about a spark proof design, by using a single solenoid system of a single plunger making one pair (two points) contact. There was no On/Off switch. Yet, Chan's design has designated one clip to be a permanent positive clip, usually red color coded and the other a permanent negative clip, usually black color coded. The plunger will not engage the contact points unless the sensing circuit detects a correct polarity connection between the pre-designated clips and external batteries. In the event of reverse connection, the solenoid will not engage and a warning signal will go off. The user will have to manually make a reconnection to correct the polarity before the solenoid will engage. In short, it does not automatically compensate for connection polarity.

This subject invention differs from Chan's previous design that it eliminates the needs for manual correction. This subject device automatically compensates for the connection polarity and accomplishes the same objectives as the Whiting's. Yet, unlike the Whiting design, it completely eliminates the On/Off switch and the complex 3 layer coils system inside the switch. This subject invention will use two independent control circuits, two separate solenoid systems with two plungers, each of which is made of one pair (two points) contact configuration. Yet, only one solenoid will engage at a given time.

### DESCRIPTION OF DRAWINGS

FIG. 1 is a diagram of the system at its standby position

FIG. 2 is a diagram of the system when its Clip 1 connected to positively charged outside battery source

FIG. 3 is a diagram of the system when its Clip 2 connected to positively charged outside battery source

FIG. 4 is a diagram of the system when its two Clips are shorting each other

FIG. 5 is a Construction diagram of the Solenoid of the device at its Open State

FIG. 6 is a Construction diagram of the Solenoid of the device at its Close State

FIG. 7 is a general Circuit diagram of the entire system

### DETAIL DESCRIPTION

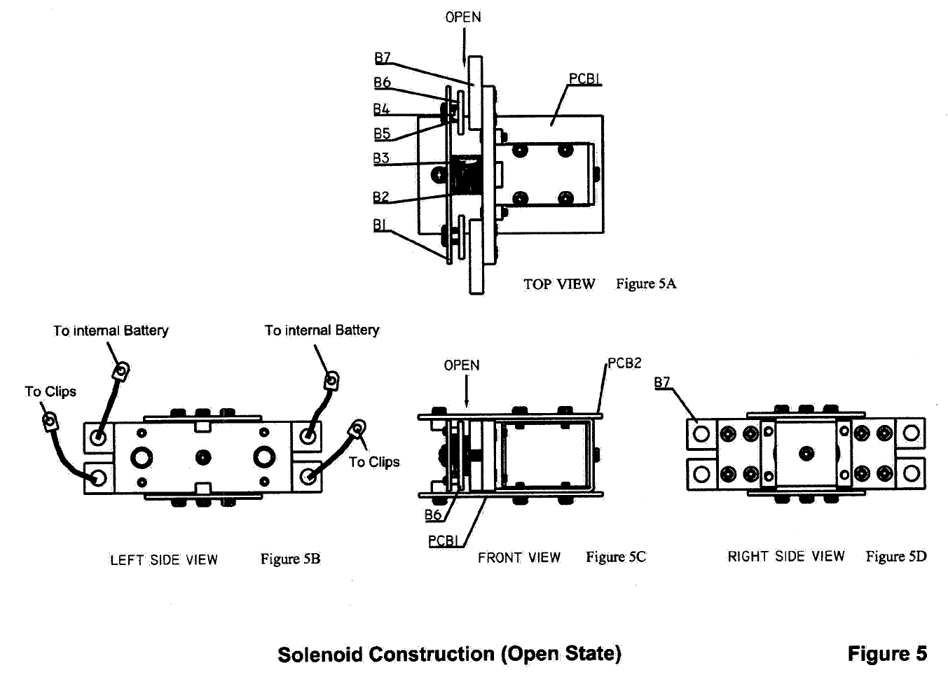

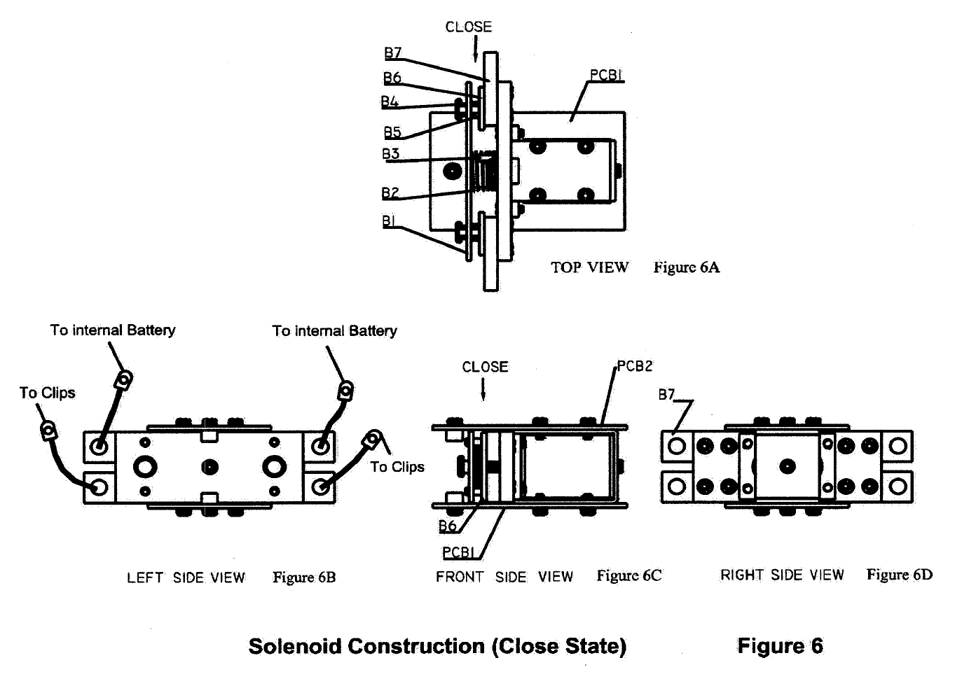

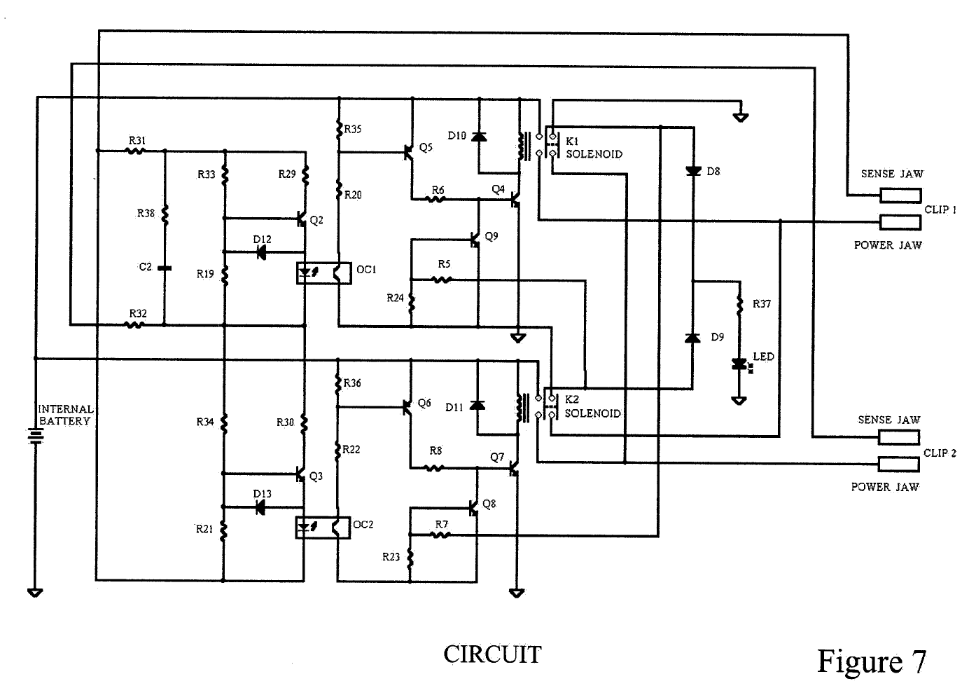

The key of the subject invention is about the use of two solenoid systems, each of which is composed of a single plunger with two points contact configuration. The construction of Solenoids K1 and K2 in FIG. 7 are identical and they are further explained in FIG. 5 and FIG. 6. A movable plunger attached to one contact plate B6 is placed inside the coil of a Solenoid. A Spring B3 is positioned between a stopper and the Contact Plate B6. Two Contact Posts B7 are positioned next to B6 but are leaving a small gap in between so that they are not in contact with B6 unless the coil of the plunger is pushed outward from the coil cavity. Once charged, the coil generates magnetic force to push plunger moving outward from the coil cavity by overpowering Spring B3. Contact Posts B7 and Contact Plate B6 will be hitting against each other to form a closed circuit for electric current (FIG. 6). Current can flow from the first Contact Post B7, through the Contact Plate B6 to the second Contact Post B7. In essence, each solenoid becomes an electronic switch for the current path at the two Contact Posts B7. The engagement of the Contact Plate and the Contact Posts at B6 and B7 will make a close circuit between the internal battery and the clip (FIG. 6B) and the disengagement of them makes an open circuit.

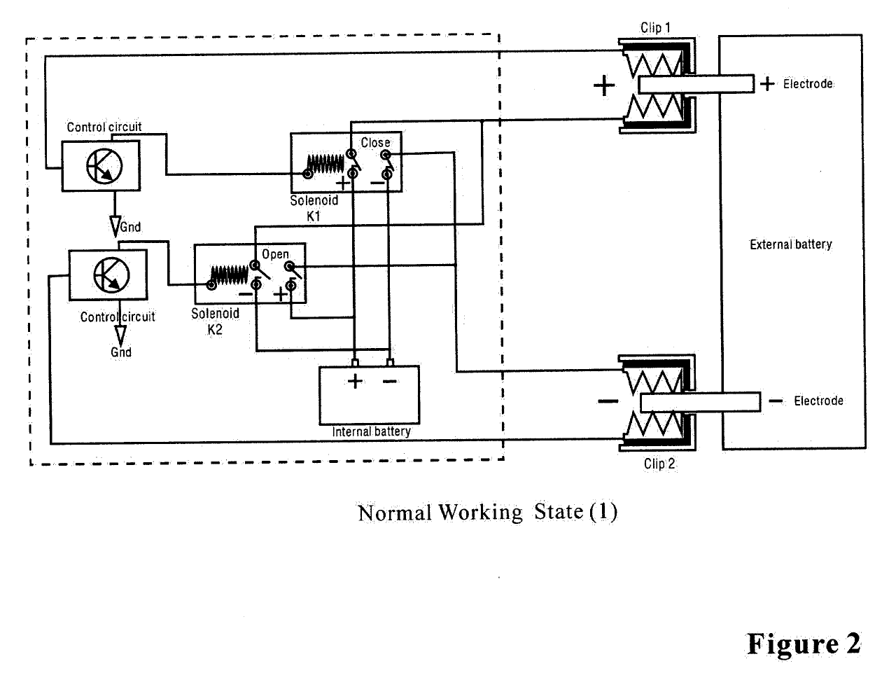

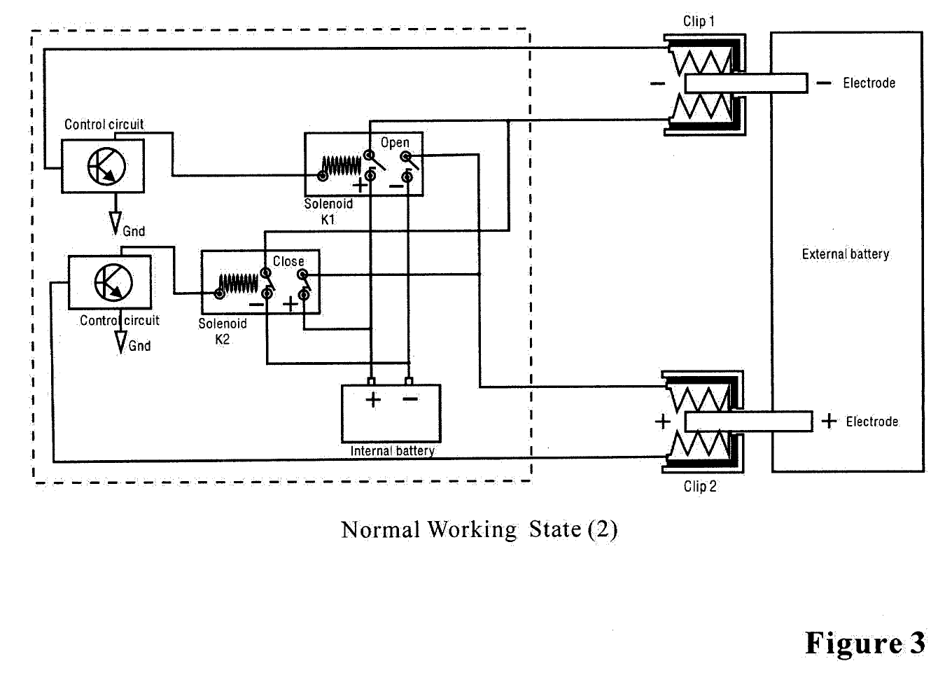

Each Solenoid is connected to the terminals of the internal battery at one end and to the output clips, Clip 1 and Clip 2 at the opposite end (FIG. 5B and FIG. 6B). However, their connection to the clips are configured in such a way that the polarity at the connection between a specific solenoid and a specific clip, such as Solenoid K1 to Clip 1 will be opposite to the polarity at the connection between the same Clip 1 to the other solenoid, Solenoid K2. That means if Clip 1 will be positively charged when Solenoid K1 engages and supplies power (FIG. 2), Clip 1 will be negatively charged when Solenoid K2 engages and supplies current (FIG. 3).

This logic of interchange polarity at connection points between solenoids and clips applies to Clip 2. If it will be negatively charged when Solenoid K1 engages and supplies current, it will be positively charged when Solenoid K2 engages and supplies current.

The engagement of the two solenoids are electronically controlled in such a way that there will only be one solenoid to be electrically charged at any given time, depending on the way the crocodile clips are connected to an outside battery. That means that only one of the two solenoids will be supplying current at any given time. The control circuit will choose which solenoid becomes the current supplying agent after the connection between the crocodile clips and the outside battery has been made. Once connected, the crocodile clip logs on the positive terminal of the outside battery supply a polarity signal back to the circuit for purpose of picking the correct solenoid for engagement. This configuration is further explained herebelow.

The following description takes reference to the general Circuit in FIG. 7.

### 1. Portable Power Pack is at Standing by Situation

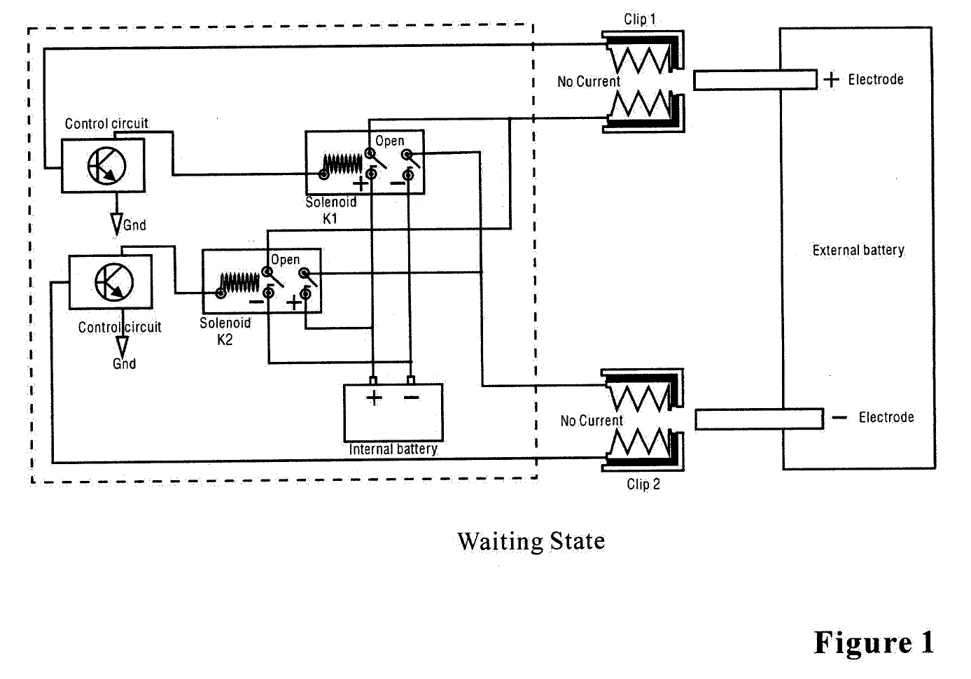

When the portable power pack of this subject invention is at standby position, the output clips are always safe and not carrying any electricity. Let's look at FIG. 1 (Waiting State), which represents the control logic when the portable battery pack is not connecting to any outside battery source. An internal battery is connected both to Solenoid K1 and Solenoid K2. Each solenoid is controlled by a separate set of control circuit. Both solenoids are at open state in this FIG. 1 because the clips are not connected to any outside polarity source. Sense Jaws of Clip 1 and Clip 2 are not sending any signal its control circuit. Specifically, both Optical Coupler OC1 and OC2 are not provided with any ground to complete its path and consequently, Solenoids K1 and K2 are not energized. The Contact Plates B6 and Hexagon Contact Posts B7 in each solenoid are at open state (details at FIG. 5A) and they are not in contact with each. The Power Jaws of output Clip 1 and output Clip 2 are not electrically loaded.

### 2. When Clip 1 is Connected to Positive

Let's now assume that the portable power pack is at use and that Clip 1 is connected to the positive terminal of the outside battery (usually a battery inside a stranded vehicle) and Clip 2 is connected to the negative polarity of the outside battery or the ground (FIG. 2). Immediately after connection, Sense Jaw of Clip 1 will pickup the positively charged signal back and it passes it onto the signal wire, which passes on the control circuit. Meanwhile, Sense Jaw of Clip 2 acts as a ground path of the voltage signal for a complete loop. The Optical Coupler OC1 is then provided with a ground and has a complete circuit. Once Optical Coupler OC1 is charged, Solenoid K1 is energized and its coil is charged. At the same time, Optical Coupler OC2 remains without ground path and is without a complete circuit, Solenoid K2 is not energized.

The coil of Solenoid K1 will push its plunger and Contact Plates B6 moving towards Contact Post B7. The engagement of B6 and B7 will form a close circuit (details at FIG. 6A) for current flow from the internal battery to the external battery: Positively charged current of the positive terminal of the internal battery flows through Solenoid K1 through its Contact Plate B6 and Contact Post B7, (details at 6B, 6C and 6D), and through the power jaw of Clip1, to the positive terminal of the outside battery. Clip 2 forms a ground for the return path. The stranded vehicle could be safely jump-started.

### 3. When Clip 2 is Connected to Positive

Let's now assume that the user makes a completely opposite connection. He or she puts Clip 2 onto the positive terminal of the outside battery and the Clip 1 onto the negative terminal of the battery or on the ground (FIG. 3). Immediately after connection, the Sense Jaw of Clip 2 will pickup and send back positively charge signal back to its control circuit through the signal wire, whereas the Sense Jaw of Clip 1 will be the ground path for the loop. The Optical Coupler OC2 is provided with a ground for a complete circuit. The Solenoid K2 is energized. At the same time, Optical Coupler OC1 remains without ground path. Solenoid K1 is not energized.

Similar to the above, the charged Solenoid K2 engages its Contact Plates B6 and Contact Post B7 and forms a close circuit (FIG. 6A). The positively charged electric current flows from the internal battery to the Solenoid K2, to Clip 2, to the positive terminal of the outside battery. Clip 1 becomes the ground between the two batteries. The stranded vehicle could be safely jump-started.

### 4. When Clip 1 and Clip 2 are Shorting Each Other

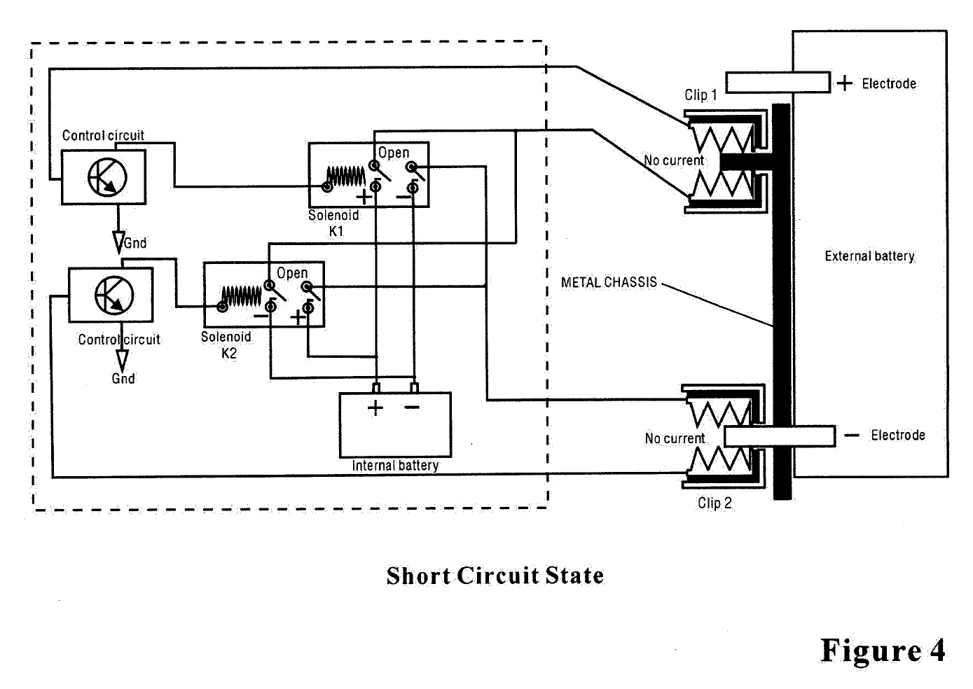

Let's now assume that the user makes a short connection between the two clips. Since both Solenoids (K1 and K2) are at stand-by position (details at FIG. 4), there is no engagement in the Contact Plates B6 and Contact Posts B7. No current will be flowing through the system and the clips are not electrically loaded. There is no dangerous shorting spark at the clips.

I claim

1. A mean of portable battery pack for boosting battery operated appliances capable of providing polarity compensation comprises of:
a) an internal battery inside a housing,
b) two crocodile clips each has two pieces of metal jaws,
c) two pairs of internal power cables connecting two solenoids and two terminals of the internal battery
d) means of two magnetic solenoid systems each of which has a single set of coil wrapped along a bobbin to form a single coil cavity
e) means of control circuit to determine which solenoid is to be charged so that polarity of internal battery always matches the connection to an external battery.

2. The apparatus of claim 1, wherein the each of the dual solenoids comprises of
a) A plunger placed inside a coil cavity of a solenoid which the plunger is so attached to,
b) one pair of external power cables connecting the solenoid and the metal jaw of the crocodile clips,
c) electronic control circuits capable of charging designated solenoid coil upon receiving polarity signal from a designated contact jaw through the signal wire,
d) one pair of contact posts positioned outside the solenoid coil cavity, providing anchor of power cables,
e) a contact plate attached to the plungers inside the coil cavity
f) a spring providing a temporary separation space gap between the contact plates and the contact posts,
g) a magnetic coil capable of producing magnetic force around its coil cavity and changing the static position of a metal plunger so placed inside the cavity.

3. The apparatus of claim 1, wherein the electronic control circuit comprises of optical coupler, resistors and diodes, which will use the current from an incoming voltage polarity signal to charge a targeted solenoid coil and will terminate such charge once such signal current is not present.

4. The apparatus of claim 1, whereas each crocodile clip comprises of one sense jaw connecting to a signal wire and whereas any sense jaw of a clip acts as a ground path of the other sense jaw in the opposite clip if the other sense jaw receives positive polarity signal.

5. The apparatus of claim 1, whereas each crocodile clip comprises of one power jaw connecting to a power cable, and whereas each power jaw of the clip acts as a ground path of the other power jaw in the opposite clip if the other power jaw is electrically charged.

6. A portable battery device for boosting battery operated appliances comprises of a mean of automatic polarity compensation without employing any means of on/off switching mechanism.

7. A mean of electronic circuit inside a portable battery pack comprising of two sets of sub-circuits, each of which is connected to external polarity sensing jaw through sense wire and each jaw is capable of acting as ground path for the opposite jaw if the said opposite jaw and its adjacent sub-circuit detects a positively charged signal.
